(19) United States
(12) Patent Application Publication
(10) Pub. No.: US 2026/0196815 A1
(43) Pub. Date: Jul. 9, 2026

(54) METHOD AND KIT FOR FLUSH MOUNTING OF SWITCHES AND SOCKETS

(71) Applicant: SHIVER NV, Veurne (BE)

(72) Inventor: Thibault RENSON, Veurne (BE)

(21) Appl. No.: 19/129,846

(22) PCT Filed: Nov. 15, 2023
(86) PCT No.: PCT/IB2023/061564

§ 371 Date: May 14, 2025

(30) Foreign Application Priority Data
Nov. 15, 2022 (BE) 2022/5919
Nov. 24, 2022 (BE) 2022/5952

(51) Int. Cl. H02G 3/12; H01R 13/74; H01R 24/76; H02G 3/08

(52) U.S. Cl. CPC H02G 3/121; H01R 13/741; H01R 24/76; H02G 3/081; H02G 3/086

(57) ABSTRACT

The present invention relates to a method for flush mounting switches and sockets, comprising the steps of providing a flush-mounted box with an opening, placing an electrical base element in the flush-mounted box, wherein a central part is placed on the base element and covers the base element, wherein a front surface of the central part is located in the flush-mounted box or in the plane of the opening, whereby there is a distance of at least 0.8 mm and a maximum of 10 mm between the central part and each side wall of the flush-mounted box along the opening, so that a gap is formed, wherein the base element is removably clicked into the flush-mounted box, wherein, after placing the base element into the flush-mounted box, a filler element is removably placed in the gap and fills the gap over the entire distance. The invention also relates to a kit for flush mounting switches and sockets.

### TECHNICAL FIELD

The invention relates to a method and a kit for flush mounting of switches and sockets, more specifically the flush mounting of switches and sockets in a wall.

### PRIOR ART

Flush-mounted boxes for switches and sockets are ubiquitous in a modern home or any other building. Typically, one or more interchangeable sockets or switches are mounted in the flush-mounted boxes, to which electrical wiring runs from the surrounding wall structure. In some cases, other electrical base elements, such as sensors, lights and other components, are mounted in the flush-mounted boxes.

Despite advancements in other areas of technology, sockets and switches have changed little for at least the better part of a century. As is known, flush-mounted boxes usually have the shape of a beam or a cylinder, the front of which is open. The flush-mounted box is attached to a wall with cement or plaster or hooked behind a plaster wall using clamps, with the open side of the flush-mounted box facing a room. Electrical wiring is led to the flush-mounted box and attached to the electrical base element. The socket, switches or other electrical base element is then installed inside the flush-mounted box. The open front side of the flush-mounted box is then covered by a cover frame with one or more openings through which the active part of the socket, the switches or the other electrical base element protrudes. This type of installation has been used for so many years that, from an aesthetic point of view, most people simply accept the presence of a visible cover frame as a necessary evil. Of course, numerous attempts have been made to improve the appearance of cover frames, but with very mixed results. At best, the cover frame has turned into a more or less decorative item, while at worst, the cover frame is an even more obvious eyesore. In recent years, the trend has been to make the cover plate simple and practical in appearance, in an attempt to minimize the visual impact as much as possible. Homes and commercial buildings, where a sophisticated look is sought, could benefit from eliminating visible cover frames. At the same time, it must be taken into account that flush-mounted boxes have important structural and safety functions. The flush-mounted box provides support for the socket, the switches or other electrical base element and also encloses the wire ends and contacts that would otherwise be exposed. The functional requirements are often described in regulations, from which deviation is not desirable or practical. Consequently, no aesthetic improvement may be made at the expense of violating these regulations.

U.S. Pat. No. 7,956,295 (US '295) describes a method and a device that allows a flush-mounted box with an electrical base element to be installed in a wall without using a visible cover frame. For this purpose, the traditional cover frame is replaced by a plate assembly, which is plastered after placement and is therefore invisible. Only the electrical base element is visible and flush-fitted into the wall. The disadvantage of the solution from US '295 is that if the electrical base element needs to be replaced or there is a fault in the electrical wiring, the plaster must be removed from the plate assembly, which must then be repaired again. US '295 describes a partial solution using a removable plate section, which means that only a smaller part of the wall needs to be repaired. In another embodiment of US '295, the electrical base element is clicked into a cylindrical body. That cylindrical body is attached to the plate assembly. Using a special tool intended for this purpose, the electrical base element can be removed from the cylindrical body without having to open the plate assembly. The plaster is not damaged in the process. The disadvantage of this embodiment is that there must be free space for the tool around the electrical base element. As a result, it is possible that the electrical base element may be tilted due to pushing of the electrical wiring, causing the electrical base element to not sit nicely in the cylindrical body and resulting in a sloppy finish. Another disadvantage is that dirt or dust can accumulate in this free space, as a result of which the electrical base element may no longer be able to be removed using the tool. In addition, it is also possible to force objects into this free space, as a result of which the electrical base element could potentially undesirably be unclicked and possibly create a safety hazard.

The present invention aims to solve at least some of the above problems or drawbacks.

### SUMMARY OF THE INVENTION

In a first aspect, the present invention relates to a method according to claim 1.

This method is particularly advantageous for centering the electrical base element in the opening of the flush-mounted box. After the electrical base element has been clicked into the flush-mounted box, it is possible that the electrical base element, due to pushing of electrical wiring on the electrical base element, may end up slightly tilted in the flush-mounted box. As a result, the gap between the central part and each side wall of the flush-mounted box is not equal or not regular around the opening of the flush-mounted box, as a result of which the aesthetic effect of an absent cover frame is partly lost. By placing a filler element in the gap, the gap is filled over the entire distance at at least one point between the central part and each side wall and at at least three points between a continuous side wall and the central part, and the electrical base element is automatically centered in the opening of the flush-mounted box.

Preferred forms of the method are set forth in claims 2-11.

A specific preferred form concerns a method according to claim 2.

This preferred form is advantageous to prevent dirt or dust from accumulating in the gap, so that a click system with which the electrical base element is clicked into the flush-mounted box remains accessible. In addition, the filler element prevents the electrical base element from being undesirably unclicked from the flush-mounted box by forcing an object into the gap, thereby avoiding a potential safety risk.

Another specific preferred embodiment concerns a method according to claim 5.

This preferred form is advantageous because it completely conceals the presence of a gap, so that a person has no indication of how the electrical base element can be removed from the wall and an inadvertent safety risk cannot arise.

In a second aspect, the present invention concerns a kit according to claim 12.

One of the advantages of this kit is that an electrical base element can be easily installed flush in a wall without a cover frame, wherein the electrical base element is automatically placed centered in the opening of the flush-mounted box by the filler element, even if electrical wiring presses on the electrical base element. This means that the aesthetic effect of the absent cover frame is not lost.

Preferred forms of the kit are described in dependent claims 13-19.

A specific preferred form concerns a kit according to claim 13.

This preferred form is advantageous to prevent dirt or dust from accumulating in a gap between the electrical base element and side walls of the flush-mounted box around the opening of the flush-mounted box after placement, as a result of which the electrical base element could no longer be unclicked from the flush-mounted box. An additional advantage is that the filler element in the kit ensures that the electrical base element cannot be undesirably unclicked from the flush-mounted box after placement by forcing an object into the gap. This avoids a possible safety risk.

### DESCRIPTION OF THE FIGURES

FIG. 1 shows a perspective view of a first step of a method according to an embodiment of the present invention.

FIG. 2 shows a perspective view of a second step of a method according to an embodiment of the present invention.

FIG. 3 shows a perspective view of a third step of a method according to an embodiment of the present invention.

FIG. 4 shows a perspective view after carrying out a method according to an embodiment of the present invention.

FIG. 5 shows a perspective view of a finished socket according to an embodiment of the present invention.

FIG. 6 shows a detail view of a central part and filler element according to an embodiment of the current invention.

FIG. 7 shows a perspective view of a first step for removing an electrical base element from a flush-mounted box.

FIG. 8 shows a perspective view of a second step for removing an electrical base element from a flush-mounted box.

FIG. 9 shows a perspective view of a third step for removing an electrical base element from a flush-mounted box.

FIG. 10 shows a perspective view after removing an electrical base element from a flush-mounted box.

FIG. 11 shows a perspective view of placement of a flush-mounted box according to an embodiment of the current invention in a second flush-mounted box.

FIG. 12 shows a cross-section of a flush-mounted box according to an embodiment of the current invention in a second flush-mounted box, wherein a central part is clamped in the flush-mounted box by a filler element.

FIG. 13 shows a cross-section of a flush-mounted box according to an embodiment of the present invention, wherein the flush-mounted box comprises a plaster plate and wherein the plaster plate is plastered.

FIG. 14 shows a cross-section of a flush-mounted box according to an alternative embodiment of the present invention, wherein the flush-mounted box comprises a plaster plate and wherein the plaster plate is plastered.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise,” “comprising,” “consist of,” “consisting of,” “provided with,” “include,” “including,” “contain,” “containing,” are synonyms and are inclusive or open terms that indicate the presence of what follows, and which do not exclude or prevent the presence of other components, characteristics, elements, members, steps, as known from or disclosed in the prior art.

Quoting numeric intervals by the endpoints includes all integers, fractions, and/or real numbers between the endpoints, including those endpoints.

In the context of this document, an electrical base element is an element that is placed through an opening in a flush-mounted box, where a functional part of the electrical base element is accessible through the opening in the flush-mounted box. Non-limiting examples of electrical base elements are sockets, switches such as switches, push-buttons, sensors, orientation lighting, data connections, multimedia connections, etc. The electrical base element typically comprises provisions for removably attaching the electrical base element in the flush-mounted box, such as clamps, keyhole slots, notches or cams for interaction with flexible arms of a click system, etc.

In the context of this document, a central part is a cover plate for covering a central part of an electrical base element. The cover plate has both an aesthetic function and a safety function. After placement, the central part covers live parts of the electrical base element. The central part usually does not cover the facilities for removably attaching the electrical base element in the flush-mounted box. Non-limiting examples of a central part are a pushing part of a switch or push-button, a cover plate of a socket, a lens of a sensor or orientation light, etc.

In the context of this document, a cover frame is a cover plate with at least one opening for a central part. After placement of the cover frame, the central part is located in the at least one opening. The cover frame preferably connects around the central part in the at least one opening. The cover frame covers, after placement, a flush-mounted box and not yet covered facilities for the removable attachment of an electrical base element in the flush-mounted box of an electrical base element placed in the flush-mounted box.

In the context of this document, concentric means having a common center, for example a common center in the case of circles, a common center in the case of squares or rectangles, where outlines of for example circles, squares or rectangles do not touch or intersect each other, wherein a distance between an outline of a first concentric circle, square or rectangle and an outline of a second concentric circle, square or rectangle remains the same along the circumference of the first concentric circle, square or rectangle and where the mentioned distance is measured perpendicular to the outline of the first concentric circle, square or rectangle.

In a first aspect, the invention concerns a method for flush mounting switches and sockets.

According to a preferred embodiment, the method comprises the steps of:
providing a flush-mounted box with an opening in a wall; and
placing an electrical base element through the opening in the flush-mounted box.

The wall can be a solid wall, such as a brick wall, a hollow wall, such as a wooden frame covered with plasterboard, a furniture wall or another suitable wall for installing electrical base elements.

The opening of the flush-mounted box is in a plane. The opening of the flush-mounted box is limited by side walls transverse to the plane of the opening. The plane of the opening is the plane in which the opening of the flush-mounted box lies. A flush-mounted box with a circular opening comprises a continuous side wall that forms a cylindrical body. A flush-mounted box with a rectangular opening comprises at least four side walls that form a beam-shaped body. The flush-mounted box can, but does not have to, include a bottom opposite the opening.

A central part is placed on the electrical base element. The central part can be placed on the electrical base element before or after placing the electrical base element in the flush-mounted box. When placing the central part before placing the electrical base element in the flush-mounted box, the central part is preferably attached to the electrical base element. The central part covers the electrical base element. A front surface of the central part is located in the flush-mounted box or in the plane of the opening of the flush-mounted box. The front surface of the central part is viewed in a direction transverse to the plane of the opening and towards the flush-mounted box. There is a gap between the central part and each side wall of the flush-mounted box along the opening of the flush-mounted box. In the case of a circular opening, each side wall is the continuous side wall that forms a cylindrical body. There is a distance of at least 0.8 mm and a maximum of 10 mm between each side wall along the opening and the central part in the plane of the opening. The distance is preferably at most 9 mm, more preferably at most 8 mm, even more preferably at most 7 mm, even more preferably at most 6 mm and most preferably at most 5 mm. The distance is measured perpendicular to each side wall. The central part and side walls along the opening are concentric when viewed in a plane parallel to the plane of the opening. The flush-mounted box comprises a central axis, transverse to the opening of the flush-mounted box and through a center of the opening. The central part also comprises a central axis, transverse to the front surface of the central part and through a center of the central part. The distance between the central part and each side wall is measured when the electrical base element is ideally placed. An ideal placement means that the central axis of the flush-mounted box and the central axis of the central part coincide. A central part that is placed on the electrical base element is advantageous because identical electrical base elements can be finished differently by placing a central part with a different color or made of a different material.

If the electrical base element must be connected to electrical wiring in the wall, this is done before placing the electrical base element in the flush-mounted box.

The electrical base element is removably clicked into the flush-mounted box. Preferably, the flush-mounted box comprises flexible arms in side walls along the opening of the flush-mounted box and the electrical base element comprises notches or cams for interaction with the flexible arms. Optionally, the flexible arms comprise barbs. Alternatively, the flush-mounted box comprises flexible arms with barbs on the bottom of the flush-mounted box. It will be apparent that a flush-mounted box can comprise flexible arms in side walls along the opening as well as on the bottom. It will also be apparent that embodiments in which the flexible arms are included in the electrical base element and in which the notches or cams for interaction with the flexible arms are included in the flush-mounted box are also part of the described invention. In other words, in the description above, the flexible arms and the notches or cams for interacting with the flexible arms are interchangeable. The flush-mounted box preferably comprises stops on side walls along the opening or on the bottom of the flush-mounted box for limiting a translational movement of the electrical base element in a direction transverse to the opening towards the flush-mounted box. This prevents the electrical base element from being pressed deeper into the flush-mounted box when pressing on the electrical base element, in particular sockets and switches.

Clicking the electrical base element into place removably is advantageous because it allows the electrical base element to be easily replaced in the event of a defect or, in the event of a wiring problem, to be easily removed to repair electrical wiring or electrical connections. Clicking the electrical base element into place is particularly advantageous to avoid the use of a cover frame. Electrical base elements are traditionally removably attached in the flush-mounted box using a mounting plate with keyhole slots. The mounting plate rests against the wall and the electrical base element is screwed through the keyhole slots to the side walls along the opening. A cover frame is necessary to hide the mounting plate. A known alternative solution is to removably attach the electrical base element in the flush-mounted box using clamps. Such clamps are folded out along the opening with screws against side walls. To this end, these screws must be freely accessible along the electrical base element, which means a larger gap must be provided, which as further described is not desirable. These clamps are usually part of a mounting plate as described previously, which again requires a cover frame.

After placing the electrical base element in the flush-mounted box, a filler element is removably placed in the gap between. The filler element can be made of flexible, compressible material or of a rigid material, or a combination of both. Non-limiting examples of suitable materials are metal, plastic and rubber. The rubber may or may not be synthetic. When using metal as a filler element, due attention must be paid to sufficient distance or isolation between the filler element and electrical parts of the electrical base element or electrical wiring. The gap is filled over the entire distance at at least one point between each side wall and the central part and at at least three points between a continuous side wall and the central part. In the case of a continuous side wall, each side wall is equal to the continuous side wall. It will be apparent that “at at least one point between each side wall and the central part” and “at at least three points between a continuous side wall and the central part” are compatible with each other. The filler element preferably has a minimum height of 2 mm, where the height of the filler element after placement in the gap is measured in a direction transverse to the plane of the opening. More preferably, the filler element has a minimum height of 3 mm, even more preferably a minimum height of 4 mm. The filler element extends in the mentioned direction transverse to the plane of the opening, whether or not up to the plane of the opening. If the filler element does not extend to the plane of the opening, the filler element is sunk into the flush-mounted box.

This method is particularly advantageous for centering the electrical base element in the opening of the flush-mounted box. After the electrical base element has been clicked into the flush-mounted box, it is possible that the electrical base element, due to the pushing of electrical wiring onto the electrical base element, may end up slightly tilted in the flush-mounted box. As a result, the gap between the central part and each side wall of the flush-mounted box is not equal or not regular around the opening of the flush-mounted box, as a result of which the aesthetic effect of an absent cover frame is partly lost. By placing a filler element in the gap, the gap is filled over the entire distance at at least one point between the central part and each side wall and at at least three points between a continuous side wall and the central part, and the electrical base element is automatically centered in the opening of the flush-mounted box.

According to an embodiment, in the event that the gap is filled at at least three points between the continuous side wall and the central part, the at least three points are not all located in the same half-space, where a diameter of the opening of the flush-mounted box lies in a plane that bounds the half-space and where said plane is perpendicular to the opening. Preferably, the at least three points are distributed evenly along an outline of the opening.

According to a preferred embodiment, the gap in a plane parallel to the opening along an outline formed by the side walls in said plane is filled by the filler element over the entire distance between the central part and each side wall. It will be apparent that in the case of a continuous side wall, each side wall is equal to the continuous side wall.

This embodiment is advantageous to prevent dirt or dust from accumulating in the gap, so that a click system with which the electrical base element is clicked into the flush-mounted box remains accessible. In addition, the filler element prevents the electrical base element from being undesirably unclicked from the flush-mounted box by forcing an object into the gap, thereby avoiding a potential safety risk.

According to a preferred embodiment, the flush-mounted box comprises a plaster plate. The plaster plate is parallel to the plane of the opening. The plaster plate extends around the opening of the flush-mounted box. The plaster plate preferably comprises ribs transverse to the surface of the plaster plate. These ribs are advantageous for better adhesion of plaster to the plaster plate. The method comprises a first additional step of attaching the flush-mounted box in a second flush-mounted box. The second flush-mounted box is preferably a traditional flush-mounted box for incorporating traditional electrical base elements, wherein the traditional electrical base elements are usually secured in such traditional flush-mounted boxes using screws or clamps. The second flush-mounted box has already been placed in the wall. The flush-mounted box is placed in the second flush-mounted box, with the plaster plate resting on the wall. The plaster plate preferably comprises keyhole slots, the flush-mounted box being screwed to the side walls of the second flush-mounted box with screws through the keyhole slots. The side walls of the second flush-mounted box comprise bushings for this purpose. This corresponds to a way in which traditional electrical base elements are attached to a traditional flush-mounted box using screws through a mounting plate, as described previously. The method includes a second additional step of plastering the plaster plate up to the opening of the flush-mounted box. Plastering can be carried out both before and after placing the electrical base element in the flush-mounted box.

This embodiment is advantageous because it avoids a visible cover frame. Only the central part and the filler element are visible. It is particularly advantageous that tradesmen can place a second flush-mounted box in the wall in a usual manner, after which the flush-mounted box is secured in the second flush-mounted box. The tradesmen do not need to use new techniques or materials. For tradesmen, mounting the flush-mounted box in the second flush-mounted box is similar to mounting a traditional electrical base element in a traditional flush-mounted box. It is also advantageous that this embodiment is very suitable for renovations if visible cover frames are no longer desired. Existing electrical wiring and traditional flush-mounted boxes already present in the wall can be reused.

According to a further embodiment, the flush-mounted box comprises a raised edge on the plaster plate. The raised edge has a height from the plaster plate of at least 1 mm and at most 10 mm. The height is measured in a direction transverse to the plaster plate. The height is preferably at least 2 mm. The height is preferably at most 9 mm, more preferably at most 8 mm, even more preferably at most 7 mm and even more preferably at most 6 mm. There is a gradual transition from the plaster plate to an upper point of the raised edge. The upper point of the raised edge is a point that is furthest from the plaster plate in the direction mentioned, transverse to the plaster plate. The raised edge preferably has a width of at most 1.0 mm at the upper point, more preferably a width of at most 0.5 mm. The plaster plate is plastered up to the upper point of the raised edge.

This embodiment is particularly advantageous for a plaster plate that is as invisible as possible. The gradual transition from the plaster plate to the upper point of the raised edge is advantageous to prevent the plaster around the raised edge from breaking off, for example due to a lack of plaster in a right angle formed between the plaster plate and the raised edge. The gradual transition is advantageous because it allows a very small width for the raised edge at the upper point without the raised edge breaking off. The very small width of the raised edge at the upper point is particularly advantageous because it makes the plaster plate virtually invisible when plastering up to the upper point. The raised edge is advantageous to prevent plaster from ending up in the opening of the flush-mounted box, which prevents a clean finish with plaster around the opening.

According to a preferred embodiment, a front surface of the filler element is located in the plane of the opening of the flush-mounted box. The front surface of the filler element is viewed in a direction transverse to the plane of the opening and towards the flush-mounted box. This embodiment is particularly advantageous for flush mounting of an electrical base element in a wall. In particular in cases where the front surface of the central part is also located in the plane of the opening of the flush-mounted box, such as a pressing surface of a switch or push-button or a lens of an orientation lighting, so that a visually continuous wall is obtained, as opposed to a traditional cover frame, where the central parts come out of the wall. Even with a front surface that is located in the flush-mounted box, such as with a socket, a visually continuous wall is obtained, with a local recess for receiving a plug of a power cord. A recessed filler element would emphasize a visible gap around the central part, which would emphasize the central part in the wall more. This embodiment is also advantageous because it completely conceals the presence of the gap, so that a person has no indication of how the electrical base element can be removed from the wall and an inadvertent safety risk cannot arise.

According to an embodiment, a front surface of the filler element projects from the plane of the opening of the flush-mounted box. The front surface of the filler element preferably extends from the plane of the opening by at most 15 mm, more preferably at most 10 mm, even more preferably at most 9 mm and even more preferably at most 8 mm. This embodiment is advantageous for incorporating an electrical base element into a thin wall. Because the filler element protrudes from the plane of the opening, the electrical base element can also be placed less deeply in the flush-mounted box, so that less depth is required in the wall. This embodiment is particularly advantageous if the electrical base element is a socket.

According to a preferred embodiment, the filler element comprises a flange. The flange lies in a plane parallel to the plane of the opening of the flush-mounted box. The flange extends in a direction away from the electrical base element. This means that the opening is not partially covered by the flange. When placing the filler element, the flange hides the flush-mounted box. The flange preferably has a width of at least 2 mm, more preferably at least 3 mm. The flange preferably has a width of at most 10 mm, more preferably at most 8 mm, even more preferably at most 6 mm. The width is measured in the plane of the opening and transverse to an edge of the opening.

This embodiment is an alternative to the previously described embodiment in which the flush-mounted box comprises a plaster plate. This embodiment is advantageous because a visible cover frame is also avoided. Only the central part and the filler element are visible.

This embodiment is particularly advantageous in combination with a previously described embodiment, in which the flush-mounted box comprises a plaster plate. When plastering the plaster plate, it is possible that the plaster around the opening is not completely flat or does not fit completely to the opening. The flange covers the plaster around the opening, creating a neat finish. In combination with a previously described embodiment in which the flush-mounted box comprises a raised edge on the plaster plate, the flange preferably rests on the raised edge.

According to a further embodiment, the method comprises the additional step of attaching the flush-mounted box in a second flush-mounted box. The second flush-mounted box is, as in the previously described embodiment in which the flush-mounted box comprises a plaster plate, a traditional flush-mounted box. The second flush-mounted box has already been placed in the wall. When placing the filler element, the flange conceals both the flush-mounted box and the second flush-mounted box.

As with the previously described embodiment in which the flush-mounted box comprises a plaster plate, this embodiment is particularly advantageous because tradesmen can install a second flush-mounted box in the wall in a conventional manner without new techniques or materials and because this embodiment is very suitable for renovations if visible cover frames are no longer desirable.

According to a preferred embodiment, the central part is attached to the electrical base element before placing the electrical base element. Attaching the central part to the electrical base element is advantageous because the central part is also immediately placed firmly in the flush-mounted box by clicking the electrical base element into place. The central part is preferably clicked onto the electrical base element. Clicking the central part onto the electrical base element is advantageous to avoid disruption of the front surface of the central part by a fastening means. Alternatively, the central part is screwed to the electrical base element using at least one screw. Preferably, the at least one screw in the front surface of the central part is not visible, for example because the at least one screw is screwed into the central part from a rear side through the electrical base element. Alternatively, the central part is attached to the electrical base element using at least one magnet. The central part or the electrical base element comprises the at least one magnet, while the electrical base element or the central part respectively comprises a ferromagnetic material. The at least one magnet is advantageous for removably attaching the central part to the electrical base element, without the front surface of the central part being disturbed by a fastening means.

According to a preferred embodiment, the central part is placed loosely on the electrical base element after placing the electrical base element in the flush-mounted box. The central part is clamped in the flush-mounted box by placing the filler element. Preferably, the filler element is made of a flexible, compressible material. A non-limiting example of a suitable material is rubber, synthetic or otherwise. A flexible, compressible material is advantageous for absorbing any margins in the dimensions of the flush-mounted box or the central part. A non-limiting example of a filler element made of a flexible, compressible material is a cylindrical shape made of rubber that is placed around the central part. The cylindrical shape may or may not comprise a bottom made of rubber, wherein the bottom is positioned between the central part and the electrical base element or wherein the bottom comprises an opening for the electrical base element. Alternatively, the filler element is made from a rigid material, such as plastic, metal or wood, and a flexible, compressible material is applied on a side of the filler element that is in contact with the flush-mounted box, on a side of the filler element that is in contact with the central part, is in contact with the electrical base element or is in contact with both, or on both said sides. An alternative to a flexible, compressible material is an annular coil spring arranged around the filler element.

This embodiment is advantageous to avoid disruption of the front surface of the central part by a fastening means. This embodiment is particularly advantageous because it allows the central part to be made from a material that is not suitable for the use of, for example, click systems, screws or magnets, such as natural stone, ceramics, glass, etc. This embodiment is extremely advantageous for the flat and virtually invisible placement of an electrical base element in a wall made of, for example, natural stone, ceramic, glass and similar materials, by providing a central part made of the same material.

According to an embodiment, the filler element is integrated into the central part. Preferably, the filler element and the central part are one piece. This embodiment is particularly advantageous in cases where the central part is placed on the electrical base element after placing the electrical base element in the flush-mounted box. Because the filler element is integrated into the central part, only one additional element needs to be installed after placement of the electrical base element, instead of two additional elements. The central part with the integrated filler element can be magnetically attached to the electrical base element, as described previously. Alternatively, the central part with integrated filler element can be attached in the flush-mounted box by clicking the filler element into the gap, as described previously. Alternatively, the central part with integrated filler element can be clamped in the gap, as described previously.

According to a preferred embodiment, the filler element is clicked into place in the gap. To this end, the filler element preferably comprises several protrusions that are accommodated in recesses in side walls along the opening of the flush-mounted box. Alternatively, the filler element comprises several protrusions that are accommodated in recesses in the central part, the electrical base element or both.

It will be apparent that the filler element can comprise protrusions that are accommodated in recesses in side walls along the opening of the flush-mounted box as well as in recesses in the central part, the electrical base element or both. It is also clear that the protrusions and recesses are interchangeable. Preferably, the filler element comprises a notch for unclicking the filler element from the gap. Alternatively, the central part comprises a notch for unclicking the filler element from the gap.

This embodiment is advantageous because the filler element can be removably placed in the gap without the use of tools.

According to an alternative embodiment, the filler element is clamped in the gap. This embodiment is also advantageous for removably placing the filler element in the gap without the use of tools. This embodiment is particularly advantageous in combination with a filler element made of a flexible, compressible material or with a filler element made of a rigid material, wherein a flexible, compressible material is provided on one or two sides, as in a previously described embodiment. An alternative to a flexible, compressible material is an annular coil spring arranged around the filler element. With a filler element made of a rigid material, the filler element preferably comprises a notch for releasing the filler element from the gap. Alternatively, the central part comprises a notch for releasing the filler element from the gap.

According to an embodiment, the flush-mounted box comprises a plurality of openings. When carrying out the method, an electrical base element and a central part are placed in each of the openings, as described in previous embodiments. This embodiment is advantageous for placing electrical base elements close to each other, wherein the electrical base elements are automatically aligned.

According to an embodiment, before placing the electrical base element in the flush-mounted box, the method comprises the additional step of orienting the electrical base element in the flush-mounted box. The electrical base element can be rotated in discrete steps of at least 30° around the central axis of the electrical base element, before the electrical base element is clicked into the flush-mounted box. The discrete steps are preferably at least 36°, more preferably at least 45°. The discrete steps are preferably at most 180°, more preferably at most 90°, even more preferably at most 60°. This embodiment is advantageous for mounting an electrical base element at an angle relative to a horizontal floor surface. This embodiment is particularly advantageous when placing a socket in a flush-mounted box, in particular with sockets placed closely together or sockets close to a surface. By rotating the socket, more free space can be created for routing a power cord.

In a second aspect, the invention concerns a kit for flush mounting switches and sockets.

According to a preferred embodiment, the kit comprises a flush-mounted box, an electrical base element, a central part and a filler element.

The flush-mounted box comprises an opening for placing the electrical base element in the flush-mounted box. The opening of the flush-mounted box is in a plane. The opening of the flush-mounted box is limited by side walls transverse to the plane of the opening. The plane of the opening is the plane in which the opening of the flush-mounted box lies. The flush-mounted box can, but does not have to, include a bottom opposite the opening. The flush-mounted box comprises fastening means for removably attaching the electrical base element in the flush-mounted box. The fastening means are suitable for clicking the electrical base element into the flush-mounted box. Preferably, the flush-mounted box comprises as fastening means flexible arms in side walls along the opening of the flush-mounted box and the electrical base element comprises notches or cams for interaction with the flexible arms. Optionally, the flexible arms comprise barbs. Alternatively, the flush-mounted box comprises flexible arms with barbs on the bottom of the flush-mounted box. It will be apparent that a flush-mounted box can comprise flexible arms in side walls along the opening as well as on the bottom. It will also be apparent that embodiments in which the flexible arms are included in the electrical base element and in which the notches or cams for interaction with the flexible arms are included in the flush-mounted box are also part of the described invention. The flush-mounted box preferably comprises stops on side walls along the opening or on the bottom of the flush-mounted box for limiting a translational movement of the electrical base element in a direction transverse to the opening towards the flush-mounted box.

The central part can be placed on the electrical base element. The central part covers the electrical base element, after mounting the electrical base element in the flush-mounted box and after placing the central part on the electrical base element.

A front surface of the central part is located in the flush-mounted box or in the plane of the opening of the flush-mounted box, after mounting the electrical base element in the flush-mounted box and after placing the central part on the electrical base element. The front surface of the central part is viewed in a direction transverse to the plane of the opening and towards the flush-mounted box. Between the central part and each side wall of the flush-mounted box, after mounting the electrical base element in the flush-mounted box and after placing the central part on the electrical base element, there is a distance of at least 0.8 mm and a maximum of 10 mm in the plane of the opening. The distance is preferably at most 9 mm, more preferably at most 8 mm, even more preferably at most 7 mm, even more preferably at most 6 mm and most preferably at most 5 mm. The distance is measured perpendicular to each side wall. The flush-mounted box comprises a central axis, transverse to the opening of the flush-mounted box and through a center of the opening. The central part also comprises a central axis, transverse to the front surface of the central part and through a center of the central part. The distance between the central part and each side wall is measured when the electrical base element is ideally placed. An ideal placement means that the central axis of the flush-mounted box and the central axis of the central part coincide.

The filler element can be removably placed in the gap, wherein the gap is filled over the entire distance by the filler element at at least one point between each side wall and the central part and at at least three points between a continuous side wall and the central part. In the case of a continuous side wall, each side wall is equal to the continuous side wall. It will be apparent that at at least one point between each side wall and the central part and at at least three points between a continuous side wall and the central part are compatible with each other. The filler element can be made of flexible, compressible material or of a rigid material. Non-limiting examples are metal, plastic and rubber. The rubber may or may not be synthetic. The filler element preferably has a minimum height of 2 mm, where the height of the filler element after placement in the gap is measured in a direction transverse to the plane of the opening. More preferably, the filler element has a minimum height of 3 mm, even more preferably a minimum height of 4 mm. After placement in the gap, the filler element extends in the mentioned direction transverse to the plane of the opening, whether or not up to the plane of the opening.

One of the advantages of this kit is that an electrical base element can be easily installed flush in a wall without a cover frame, wherein the electrical base element is automatically placed centered in the opening of the flush-mounted box by the filler element, even if electrical wiring presses on the electrical base element. This means that the aesthetic effect of the absent cover frame is not lost.

According to an embodiment, in the event that after placement of the filler element the gap is filled at at least three points between the continuous side wall and the central part, the at least three points are not all located in the same half-space, where a diameter of the opening of the flush-mounted box lies in a plane that bounds the half-space and where said plane is perpendicular to the opening. Preferably, the at least three points are distributed evenly along an outline of the opening.

According to a preferred embodiment, the filler element can be removably placed in the gap, whereby the gap in a plane parallel to the opening is filled along an outline formed by the side walls in the said plane over the full distance between the central part and each side wall. It will be apparent that in the case of a continuous side wall, each side wall is equal to the continuous side wall.

This embodiment is advantageous to prevent dirt or dust from accumulating in the gap between the electrical base element and side walls of the flush-mounted box around the opening of the flush-mounted box after placement, as a result of which the electrical base element could no longer be unclicked from the flush-mounted box. An additional advantage is that the filler element in the kit ensures that the electrical base element cannot be undesirably unclicked from the flush-mounted box after placement by forcing an object into the gap. This avoids a possible safety risk.

According to a preferred embodiment, the flush-mounted box comprises a plaster plate. The plaster plate is parallel to the plane of the opening. The plaster plate extends around the opening of the flush-mounted box. The plaster plate preferably comprises ribs transverse to the surface of the plaster plate. These ribs are advantageous for better adhesion of plaster to the plaster plate. The plaster plate preferably comprises keyhole slots for attaching the plaster plate on a wall or for mounting the flush-mounted box in a second flush-mounted box. The second flush-mounted box is a traditional flush-mounted box.

This embodiment is advantageous for avoiding a visible cover frame. The plaster plate is suitable for plastering, after which only the central part and the filler element are visible. A kit according to this embodiment is particularly advantageous because the flush-mounted box is suitable to be attached in a conventional manner for attaching a traditional electrical base element in a traditional flush-mounted box in a second flush-mounted box. This also makes this kit very advantageous for renovations.

According to a further embodiment, the flush-mounted box comprises a raised edge on the plaster plate around the opening. The raised edge has a height from the plaster plate of at least 1 mm and at most 10 mm. The height is measured in a direction transverse to the plaster plate. The height is preferably at least 2 mm. The height is preferably at most 9 mm, more preferably at most 8 mm, even more preferably at most 7 mm and even more preferably at most 6 mm. There is a gradual transition from the plaster plate to an upper point of the raised edge. The upper point of the raised edge is a point that is furthest from the plaster plate in the direction mentioned, transverse to the plaster plate. The raised edge preferably has a width of at most 1.0 mm at the upper point, more preferably a width of at most 0.5 mm.

This embodiment is particularly advantageous for a plaster plate that is as invisible as possible. The gradual transition from the plaster plate to the upper point of the raised edge is advantageous to prevent the plaster around the raised edge from breaking off after plastering the plaster plate. The gradual transition is advantageous because it allows a very small width for the raised edge at the upper point without the raised edge breaking off. The very small width of the raised edge at the upper point is particularly advantageous because it makes the plaster plate virtually invisible after plastering. The raised edge is advantageous to prevent plaster from ending up in the opening of the flush-mounted box during plastering of the plaster plate.

According to a preferred embodiment, after placement of the filler element, a front surface of the filler element is located in the plane of the opening of the flush-mounted box. The front surface of the filler element is viewed in a direction transverse to the plane of the opening and towards the flush-mounted box. This embodiment is particularly advantageous for flush mounting of an electrical base element in a wall. A recessed filler element would emphasize a visible gap around the central part, which would emphasize the central part in the wall more. It is also advantageous that the presence of a gap is completely hidden, so that a person has no indication of how the electrical base element can be removed from the wall and a safety risk cannot unintentionally arise.

According to a preferred embodiment, the filler element comprises a flange.

After placement of the filler element, the flange lies in a plane parallel to the plane of the opening of the flush-mounted box. After placement of the filler element, the flange extends in a direction away from the electrical base element and at least beyond the flush-mounted box. The flange preferably has a width of at least 2 mm, more preferably at least 3 mm. The flange preferably has a width of at most 10 mm, more preferably at most 8 mm, even more preferably at most 6 mm. The width is measured in the plane of the opening and transverse to an edge of the opening.

This embodiment is an alternative to the previously described embodiment in which the flush-mounted box comprises a plaster plate. This embodiment is very suitable for renovations if visible cover frames are no longer desired. The kit can be used by tradesmen in a conventional manner without new techniques or materials.

This embodiment is particularly advantageous in combination with a previously described embodiment, in which the flush-mounted box comprises a plaster plate. When plastering the plaster plate, it is possible that the plaster around the opening is not completely flat or does not fit completely to the opening. The flange covers the plaster around the opening, creating a neat finish. In combination with a previously described embodiment in which the flush-mounted box comprises a raised edge on the plaster plate, the flange preferably rests on the raised edge.

According to a preferred embodiment, the filler element can be clicked into the flush-mounted box. To this end, the filler element preferably comprises several protrusions that are accommodated in recesses in side walls along the opening of the flush-mounted box. Alternatively, the filler element comprises several protrusions that are accommodated in recesses in the central part, the electrical base element or both. It will be apparent that the filler element can comprise protrusions that are accommodated in recesses in side walls along the opening of the flush-mounted box as well as in recesses in the central part, the electrical base element or both. It is also clear that the protrusions and recesses are interchangeable. Preferably, the filler element comprises a notch for unclicking the filler element from the gap.

This embodiment is advantageous because the filler element can be removably placed in the gap without the use of tools.

According to an alternative embodiment, the filler element can be clamped in the flush-mounted box. This embodiment is also advantageous for removably placing the filler element in the gap without the use of tools. This embodiment is particularly advantageous in combination with a filler element made of a flexible, compressible material. Such a filler element is particularly advantageous in combination with a central part made of, for example, natural stone, ceramic, glass, etc.

One skilled in the art will appreciate that a method according to the first aspect is preferably performed with a kit according to the second aspect and that a kit according to the second aspect is preferably suitable for performing a method according to the first aspect. Each feature described in this document, both above and below, can therefore relate to any of the two aspects of the present invention.

In what follows, the invention is described by way of non-limiting figures illustrating the invention, and which are not intended to and should not be interpreted as limiting the scope of the invention.

### DESCRIPTION OF THE FIGURES

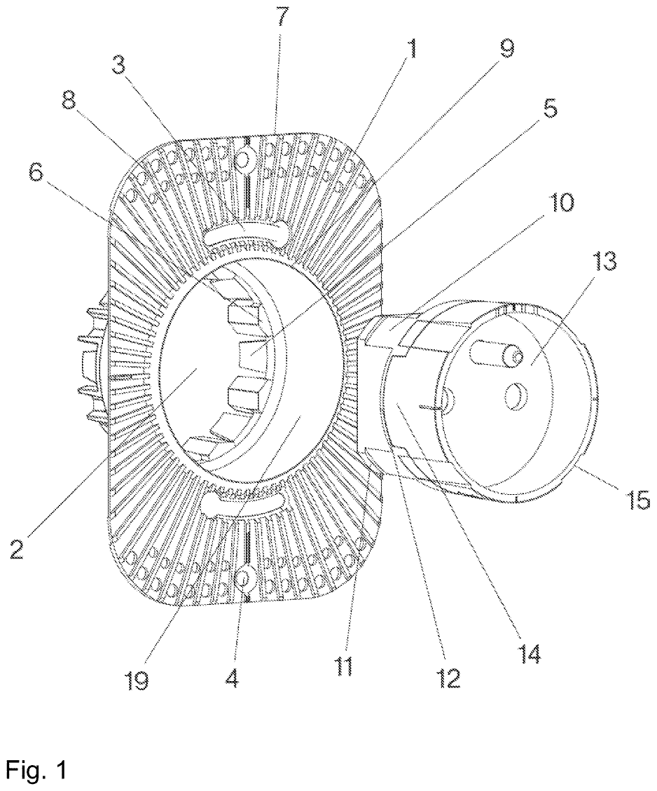

FIG. 1 shows a perspective view of a first step of a method according to an embodiment of the present invention.

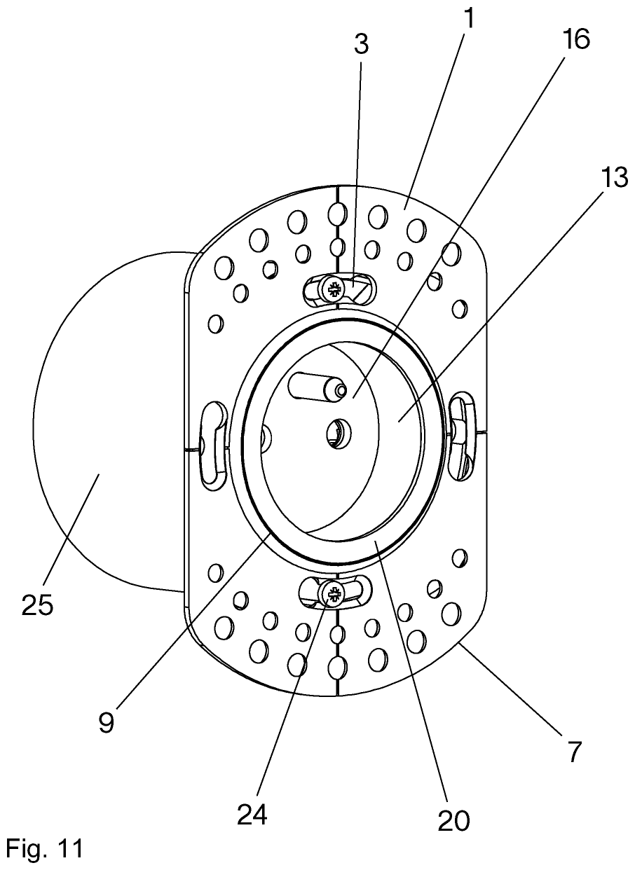

In the first step, a flush-mounted box (1) is provided in a wall (22). For better visibility, the wall (22) is not shown on FIGS. 1 through 4. The flush-mounted box (1) has an opening (2). The opening (2) here is circular. The opening (2) lies in a plane. The opening (2) is bounded by a continuous side wall (19). The side wall (19) is transverse to the plane of the opening (2). The side wall (19) forms a cylindrical volume. In this embodiment, the flush-mounted box (1) has no bottom opposite the opening (2). The flush-mounted box (1) further comprises a plaster plate (7). The plaster plate (7) is parallel to the plane of the opening (2). The plaster plate (7) extends around the opening (2). The flush-mounted box (1) is placed in a second flush-mounted box (25), more specifically the cylindrical volume of the flush-mounted box (1) is placed in the second flush-mounted box (25). The second flush-mounted box (25) is not shown in FIGS. 1 to 4 for better visibility. The second flush-mounted box (25) is shown in FIG. 11. The plaster plate (7) comprises ribs (8) for better adhesion of plaster to the plaster plate (7). The plaster plate (7) rests on the wall (22). The plaster plate (7) has keyhole slots (3) and screw holes (4) for fixing the flush-mounted box (1) to the wall (22) or to the second flush-mounted box (25) using screws. The actual mounting of the flush-mounted box (1) will be explained in FIG. 11. The following figures show an alternative embodiment of the plaster plate (7), which does not include ribs (8) or screw holes (4). The plaster plate (7) comprises a raised edge (9) around the opening (2). There is a gradual transition from the plaster plate (7) to an upper point of the raised edge (9). The plaster plate (7) is plastered up to the upper point of the raised edge (9), so that the flush-mounted box (1) is almost completely hidden. The flush-mounted box (1) further comprises flexible arms (5) for clicking an electrical base element (10) into place. The electrical base element in this case is a socket, but as described previously could also be a switch, push-button, sensor, etc. The electrical base element (10) comprises cams (11) for interaction with the flexible arms (5). When placing the electrical base element (10) in the flush-mounted box (1), the flexible arms (5) are pushed away by the cams (11). After the cams (11) have passed the flexible arms (5), the flexible arms (5) return to their original position, causing the electrical base element (10) to click into the flush-mounted box (1). The flush-mounted box comprises several flexible arms (5) so that when placing the electrical base element (5) in the flush-mounted box (2), it is possible to orient the electrical base element (5) in the flush-mounted box (2). In this embodiment, the electrical base element (10) can be rotated in discrete steps of 45° around a central axis of the electrical base element (10). In FIG. 1, the electrical base element (10) has been rotated 45° counterclockwise relative to a more typical horizontal orientation of a socket. The flush-mounted box (1) comprises several stops (6) on the side wall (19). The electrical base element (10) comprises an edge (12). After clicking the electrical base element (10) into the flush-mounted box (1), the edge (12) rests against stops (6). The stops (6) limit a translational movement of the electrical base element (10) in a direction transverse to the opening (2) towards the flush-mounted box (1). In this embodiment, the stops (6) are particularly advantageous to prevent the electrical base element (10) from being pressed deeper into the flush-mounted box (1) when a plug is inserted into the socket. A central part (13) is placed on the electrical base element (10). The central part (13) is clicked onto the electrical base element (10) before placement of the electrical base element (10) in the flush-mounted box (1). For this purpose, protrusions (14) of the central part are accommodated in invisible recesses in the electrical base element (10). The central part (13) comprises a notch (15) for releasing the filler element (20). The filler element (20) is not shown in FIG. 1.

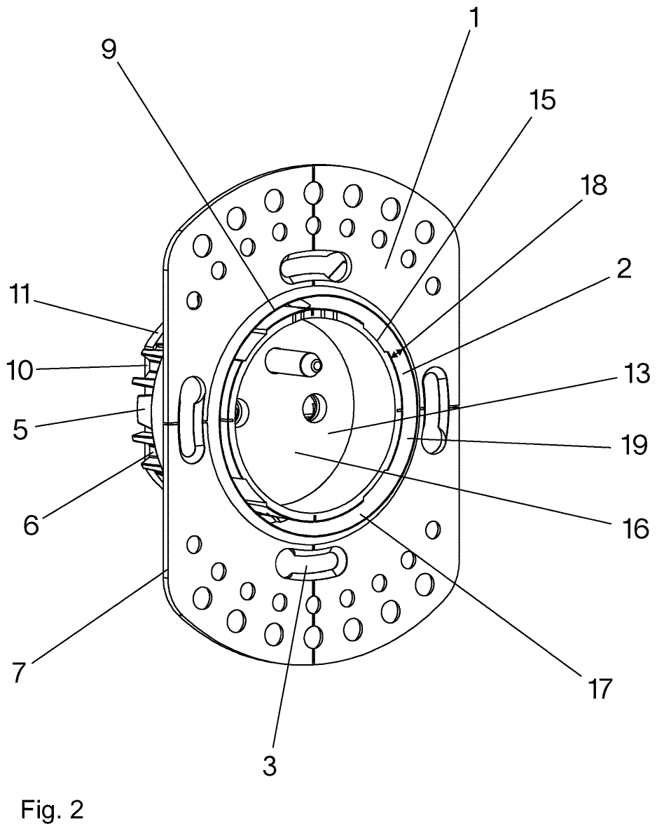

FIG. 2 shows a perspective view of a second step of a method according to an embodiment of the present invention.

The second step follows the first step in FIG. 1. In the second step, the electrical base element (10) is placed through the opening (2) in the flush-mounted box (1). The electrical base element (10) is removably clicked into the flush-mounted box (1). The flexible arms (5) have returned to their original position. The cams (11) now lie beyond the flexible arms (5) and prevent the electrical base element (10) from being removed from the flush-mounted box (1). The edges (12) of the electrical base element (10) rest against stops (6). A front surface (16) of the central part (13) is located in the flush-mounted box (1). The front surface (16) of the central part (13) is viewed in a direction transverse to the plane of the opening (2) and towards the flush-mounted box (1). There is a gap (17) between the central part (13) and the side wall (19) along the opening (2) of the flush-mounted box (1). There is a distance (18) of at least 0.8 mm and a maximum of 10 mm between the central part (13) and the side wall (19) of the flush-mounted box (1). The distance (18) is measured transversely to the side wall (19).

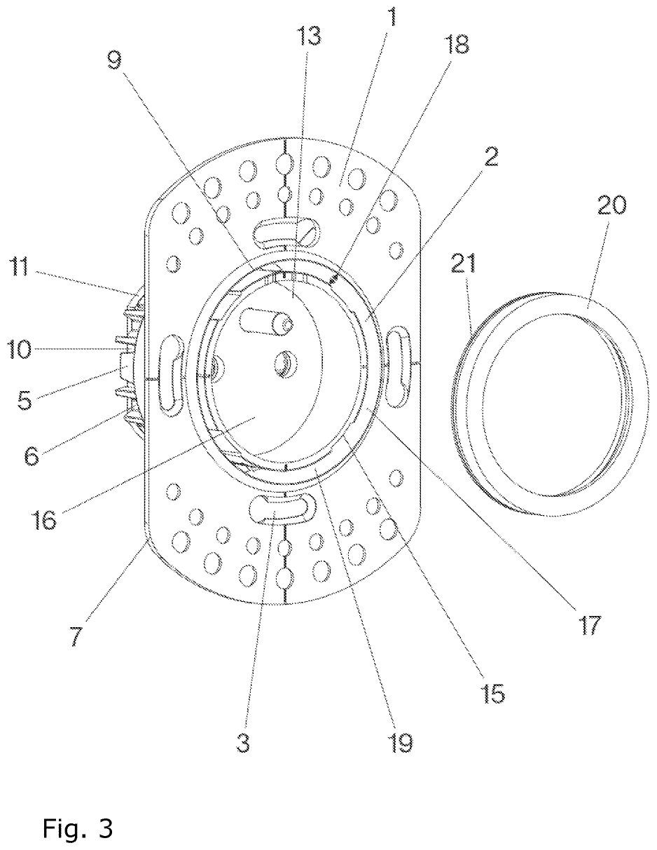

FIG. 3 shows a perspective view of a third step of a method according to an embodiment of the present invention.

The third step follows the second step in FIG. 2. In a third step a filler element (20) is provided. The filler element (20) in this embodiment is a ring-shaped element made of plastic. On one side of the filler element (20) that is in contact with the side wall (19) of the flush-mounted box, an annular coil spring (21) is arranged around the filler element (20). The filler element (20) is removably placed in the gap (17). The gap (17) is filled over the entire distance (18) between the side wall (19) and the central part (13) by the filler element (20). The filler element (20) is clamped in the gap (17) with the help of the annular coil spring (21).

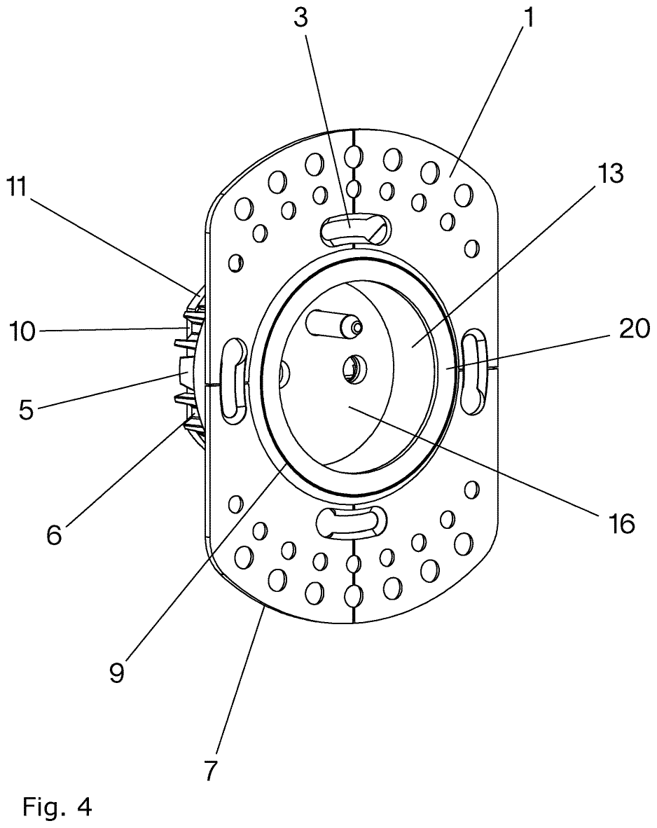

FIG. 4 shows a perspective view after carrying out a method according to an embodiment of the present invention.

FIG. 4 shows the result after performing the third step in FIG. 3. The gap (17) is filled over the entire distance (18) between the side wall (19) and the central part (13). The filler element (20) is clamped in the gap (17) with the help of the annular coil spring (21). A front surface of the filler element (20) is located in the plane of the opening (2) of the flush-mounted box (1). The central part (13) is automatically centered in the opening (2) of the flush-mounted box (1) by the filler element (20).

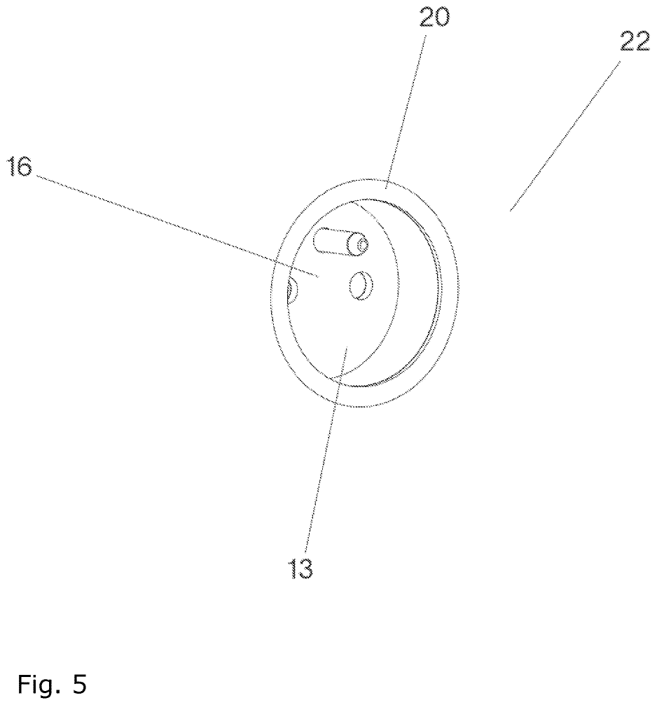

FIG. 5 shows a perspective view of a finished socket according to an embodiment of the present invention.

FIG. 5 shows the situation as in FIG. 4, but with a view of the wall (22). A layer of plaster covers the plaster plate (7). Only the central part (13) and the filler element (20) are visible, with the front surface of the filler element (20) lying in the plane of the wall (22).

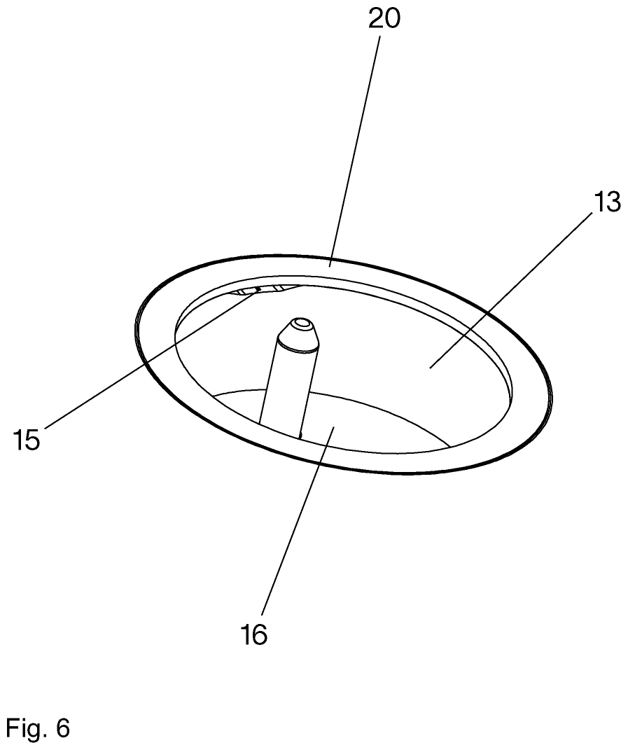

FIG. 6 shows a detail view of a central part and filler element according to an embodiment of the current invention.

FIG. 6 clearly shows the notch (15) in the central part (13). The notch (15) is located just below the filler element (20). The notch (15) is useful for releasing the filler element (20) using a flathead screwdriver.

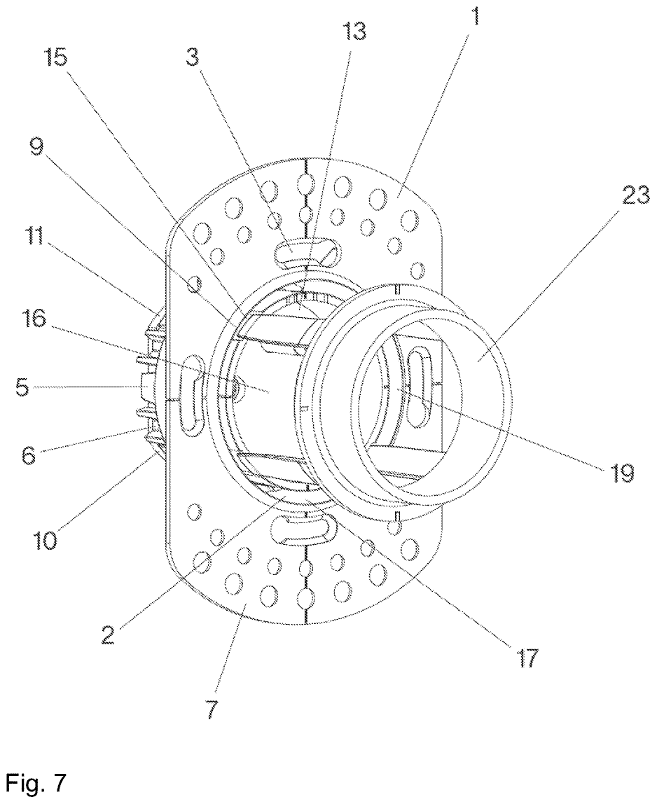

FIG. 7 shows a perspective view of a first step for removing an electrical base element from a flush-mounted box.

For better visibility, the wall (22) in FIGS. 7 to 10 is not shown. In FIG. 7 the filler element (20) has already been released. A tool (23) is used to remove the electrical base element (10). The tool (23) comprises elongated protrusions that fit into the gap (17). The elongated protrusions of the tool (23) are guided along the central part (13) and along the electrical base element (10). The elongated protrusions of the tool (23) push the flexible arms (5) outwards. Because the flexible arms (5) want to return to their original position, the elongated protrusions of the tool are pressed against the electrical base element (10) and the central part (13).

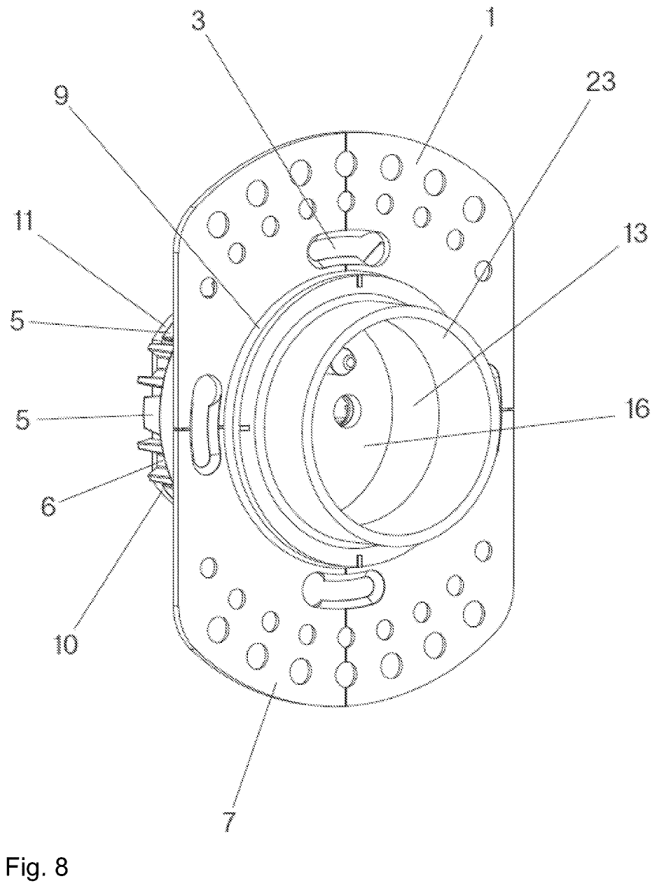

FIG. 8 shows a perspective view of a second step for removing an electrical base element from a flush-mounted box.

In FIG. 8, the tool (23) is pressed completely against the flush-mounted box (1). The flexible arms (5) are pushed out so far that they no longer interact with the cams (11). The electrical base element (10) is no longer clicked into place.

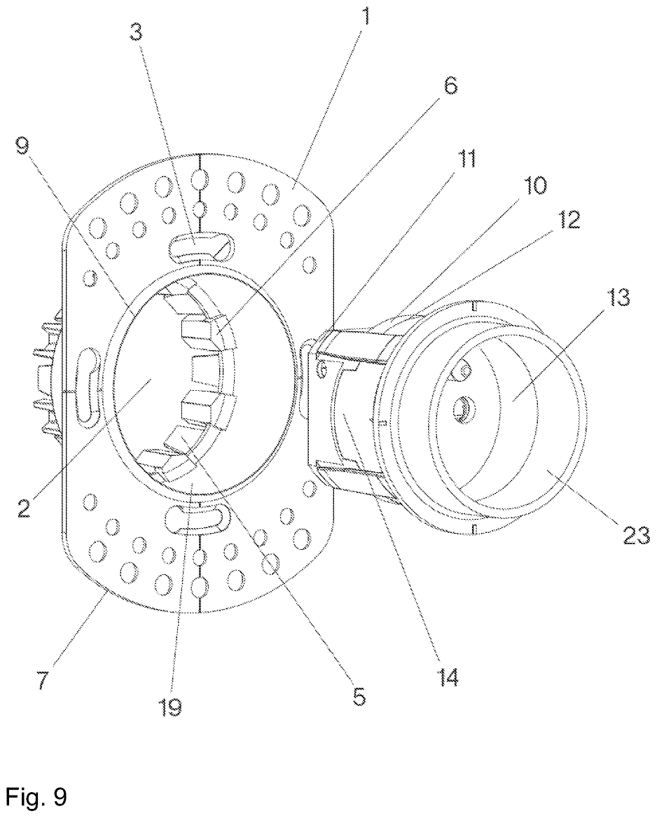

FIG. 9 shows a perspective view of a third step for removing an electrical base element from a flush-mounted box.

In a third step, the tool (23) is again pushed out of the gap (17). Because the elongated protrusions of the tool (23) press against the electrical base element (10) and the central part (13), the electrical base element (10) slides out of the flush-mounted box (1).

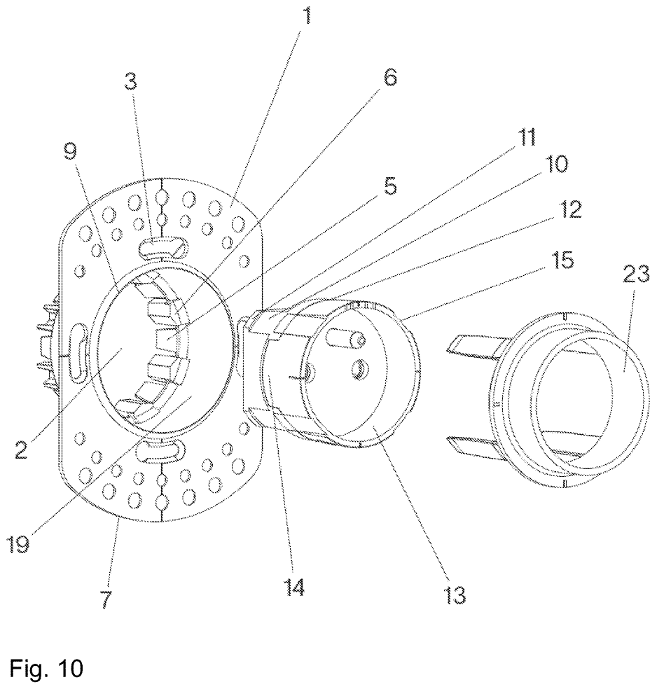

FIG. 10 shows a perspective view after removing an electrical base element from a flush-mounted box.

In FIG. 10, the electrical base element (10) has been completely removed from the flush-mounted box (1). The flexible arms (5) have returned to their original position, making it possible to place and click into place an electrical base element (10) in the flush-mounted box (1) again. The removed electrical base element (10) and the central part (13) have been removed from the tool (13).

FIG. 11 shows a perspective view of placement of a flush-mounted box according to an embodiment of the current invention in a second flush-mounted box.

In FIG. 11, the flush-mounted box (1) is placed in a second flush-mounted box (25). The second flush-mounted box (25) is a traditional flush-mounted box for flush mounting of a traditional electrical base element. The second flush-mounted box (25) is placed in the wall (22). The flush-mounted box (1) is attached to the second flush-mounted box (25) through the keyhole slots (3) using screws (24).

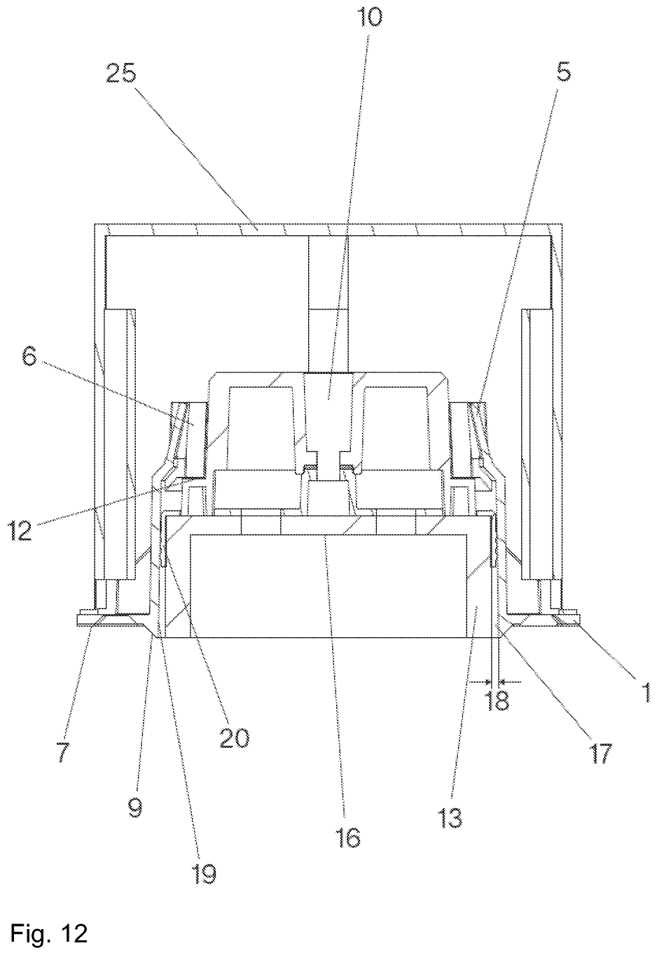

FIG. 12 shows a cross-section of a flush-mounted box according to an embodiment of the current invention in a second flush-mounted box, wherein a central part is clamped in the flush-mounted box by a filler element.

FIG. 12 is similar to the situation shown in FIG. 11, but with an alternative embodiment of the central part (13) and the filler element (20). Referring to FIG. 11, the cross-section is in a horizontal plane at the level of the horizontal lines on the plaster plate (7) that are transverse to the keyhole slots (3). In this embodiment, the central part (13) is clamped in the flush-mounted box (1) by placing the filler element (20). In this embodiment, the central part (13) is, for example, made of natural stone, glass or ceramic. The filler element (20) is made of a flexible, compressible material, such as synthetic rubber. The filler element (20) is cylindrical with a bottom. The bottom of the filler element (20) comprises an opening for the electrical base element (10).

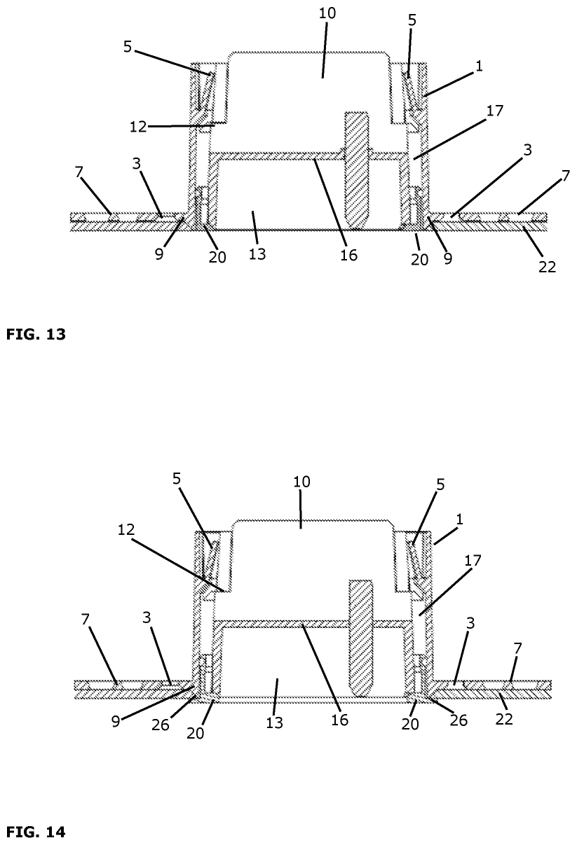

FIG. 13 shows a cross-section of a flush-mounted box according to an embodiment of the present invention, wherein the flush-mounted box comprises a plaster plate and wherein the plaster plate is plastered.

FIG. 13 is similar to the situation shown in FIG. 11, but where the plaster plate (7) is plastered. Referring to FIG. 11, the section is in a vertical plane at the level of the vertical lines on the plaster plate (7) that are perpendicular to the keyhole slots (3). By plastering the plaster plate (7), the wall (22) visually extends to the opening (2) of the flush-mounted box (1). The filler element (20) is placed in the opening (2). A front surface of the filler element (2) lies in the plane of the opening (2).

FIG. 14 shows a cross-section of a flush-mounted box according to an alternative embodiment of the present invention, wherein the flush-mounted box comprises a plaster plate and wherein the plaster plate is plastered.

FIG. 14 is very similar to FIG. 13. The difference is that the filler element (2) comprises a flange (26). The flange (26) lies in a plane parallel to the plane of the opening (2) of the flush-mounted box (1). The flange (26) extends in a direction away from the electrical base element (10). The flange (26) rests on the raised edge (9) around the opening (2). The flange (6) hides the flush-mounted box.

The numbered elements in the figures are:
1. Flush-mounted box
2. Opening
3. Keyhole slot
4. Screw hole
5. Flexible arm
6. Stop
7. Plaster plate
8. Rib
9. Raised edge
10. Electrical base element
11. Cam
12. Edge
13. Central part
14. Protrusion
15. Notch
16. Front surface
17. Gap
18. Distance
19. Side wall
20. Filler element
21. Annular coil spring
22. Wall
23. Tool
24. Screw
25. Second flush-mounted box
26. Flange

1. A method for flush mounting switches and sockets, comprising:
providing a flush-mounted box with an opening in a wall, the opening of the flush-mounted box lying in a plane; and
placing an electrical base element through the opening in the flush-mounted box, wherein a central part is placed on the electrical base element, wherein the central part covers the electrical base element, wherein a front surface of the central part is located in the flush-mounted box or in the plane of the opening of the flush-mounted box, wherein there is a gap between the central part and each side wall of the flush-mounted box along the opening of the flush-mounted box, wherein in the plane of the opening between each side wall and the central part there is a distance of at least 0.8 mm and at most 10 mm, and where the electrical base element is removably clicked into the flush-mounted box;
characterized in that after placing the electrical base element in the flush-mounted box, a filler element is removably placed in the gap, wherein the gap is filled over the entire distance by the filler element at at least one point between each side wall and the central part and at at least three points between a continuous side wall and the central part.

2. The method according to claim 1, characterized in that the gap in a plane parallel to the opening along an outline, formed by all side walls in said plane, is filled by the filler element over the entire distance between the central part and each side wall.

3. The method according to claim 1, characterized in that the flush-mounted box comprises a plaster plate, where the plaster plate is parallel to the plane of the opening and extends around the opening of the flush-mounted box, wherein the method comprises a first additional step of attaching the flush-mounted box in a second flush-mounted box, where the second flush-mounted box is already installed in the wall, and wherein the method comprises a second additional step of plastering the plaster plate up to the opening of the flush-mounted box.

4. The method according to claim 3, characterized in that the flush-mounted box comprises a raised edge around the opening on the plaster plate, wherein the raised edge has a height from the plaster plate of at least 1 mm and at most 10 mm, wherein there is a gradual transition from the plaster plate to an upper point of the raised edge and wherein the plaster plate is plastered up to the upper point of the raised edge.

5. The method according to claim 1, characterized in that a front surface of the filler element is located in the plane of the opening of the flush-mounted box.

6. The method according to claim 1, characterized in that the filler element comprises a flange, wherein the flange lies in a plane parallel to the plane of the opening of the flush-mounted box and extends in a direction away from the electrical base element, whereby when placing the filler element, the flange conceals the flush-mounted box.

7. The method according to claim 6, characterized in that the method comprises an additional step of attaching the flush-mounted box in a second flush-mounted box, wherein the second flush-mounted box has already been placed in the wall and whereby when placing the filler element, the flange hides both the flush-mounted box and the second flush-mounted box.

8. The method according to claim 1, characterized in that the central part is attached to the electrical base element before placing the electrical base element.

9. The method according to claim 1, characterized in that the central part is placed loosely on the electrical base element after placing the electrical base element in the flush-mounted box, wherein the central part is clamped in the flush-mounted box by placing the filler element.

10. The method according to claim 1, characterized in that the filler element is clicked into place in the gap.

11. The method according to claim 1, characterized in that the filler element is clamped in the gap.

12. A kit for flush mounting of switches and sockets, comprising a flush-mounted box, an electrical base element and a central part, wherein the flush-mounted box comprises an opening for placing the electrical base element in the flush-mounted box, the opening of the flush-mounted box lying in a plane, wherein the flush-mounted box comprises mounting means for removably attaching the electrical base element in the flush-mounted box, wherein the central part can be placed on the electrical base element, wherein the central part covers the electrical base element after mounting the electrical base element in the flush-mounted box and after placing the central part on the electrical base element, wherein a front surface of the central part is located in the flush-mounted box or in the plane of the opening of the flush-mounted box, wherein there is a gap between the central part and each side wall of the flush-mounted box along the opening of the flush-mounted box, wherein in the plane of the opening between each side wall and the central part there is a distance of at least 0.8 mm and at most 10 mm, characterized in that the kit further comprises a filler element, wherein the filler element can be removably placed in the gap, wherein the gap is filled over the entire distance by the filler element at at least one point between each side wall and the central part and at at least three points between a continuous side wall and the central part.

13. The kit according to claim 12, characterized in that the filler element can be removably placed in the gap, whereby the gap in a plane parallel to the opening is filled along an outline formed by all side walls in the said plane over the full distance between the central part and each side wall.

14. The kit according to claim 13, characterized in that the flush-mounted box comprises a plaster plate, where the plaster plate is parallel to the plane of the opening and extends around the opening of the flush-mounted box.

15. The kit according to claim 14, characterized in that the flush-mounted box comprises a raised edge around the opening on the plaster plate, wherein the raised edge has a height from the plaster plate of at least 1 mm and at most 10 mm and wherein there is a gradual transition from the plaster plate to an upper point of the raised edge.

16. The kit according to claim 12, characterized in that after placement of the filler element, a front surface of the filler element is located in the plane of the opening of the flush-mounted box.

17. The kit according to claim 12, characterized in that the filler element comprises a flange, wherein, the flange, after placement of the filler element, lies in a plane parallel to the plane of the opening of the flush-mounted box, extends in a direction away from the electrical base element and at least beyond the flush-mounted box.

18. The kit according to claim 12, characterized in that the filler element can be clicked into place in the flush-mounted box.

19. The kit according to claim 12, characterized in that the filler element can be clamped in the flush-mounted box.
